(19) United States
(12) Patent Application Publication
(10) Pub. No.: US 2018/0184602 A1
(43) Pub. Date: Jul. 5, 2018

(54) PLANT GROWING SYSTEM AND METHOD

(71) Applicant: CORSICA INNOVATIONS INC., Greeley, CO (US)

(72) Inventors: Jonathan Shalom OFIR, Irvine, CA (US); Eran MORDECHAY, Tel Aviv (IL); Elad WEIDMAN, Rehovot (IL); Jenny MRECI, Holon (IL); Shahar NISSIM, Herzliya (IL); Zachary Michael ZASADA, Greeley, CO (US); Ranan ROTENBERG, Tel Aviv (IL)

(21) Appl. No.: 15/739,944

(22) PCT Filed: Jun. 23, 2016
(86) PCT No.: PCT/IL2016/050681

§ 371 Date: Dec. 26, 2017

Related U.S. Application Data
(60) Provisional application No. 62/183,303, filed on Jun. 23, 2015.

(51) Int. Cl. A01G 31/02; A01G 9/20; A01G 9/24; A01G 25/16

(52) U.S. Cl. CPC A01G 31/02; A01G 25/167; A01G 9/24; A01G 9/20

(57) ABSTRACT

A plant growing system is presented. The plant-growing system comprises a control system configured for controlling plant growth in a plant growing cell inside a plant growing device under insulated environmental conditions. The control system comprises: data input utility for receiving sensing data comprising data indicative of one or more physical parameters of the plant being grown under said insulated environmental conditions, and data indicative of one or more environmental conditions at least inside said plant growing device; and data processor utility comprising a first analyzer utility for analyzing said data indicative one or more environmental conditions, a second analyzer utility for analyzing said data indicative of the one or more physical parameters of the plant, and determining a time pattern of each of said one or more parameters of the plant, and upon identifying a predetermined change in said one or more parameters of the plant, generating operational data comprising at least flow data for operating a dosing system being in fluid communication with the plant growing device for supplying a plurality of nutrients into the plant growing cell under a predetermined growth protocol.

### TECHNOLOGICAL FIELD

The present invention is in the field of plant growing; and relates to a system and method providing an automatically controlled plant growth environment. The invention is particularly useful for indoors plant growing applications.

### BACKGROUND

Growing plants indoors has the advantages of faster growing due to potentially better control over the growing environment, such as light, water, fertilizers, humidity, used to cultivate the plant. Yet, growing plants indoors is relatively expensive and complicated, especially to layman having no prior expertise, since usually a plant passes through several growth stages being different in their required conditions. In addition, growing plants indoors may produce a strong smell which is undesired.

Various techniques have been developed for facilitating indoors method for growing plants. For example, Patent Publication KR101426036B discloses a smart plant growing equipment for home use used to simply grow plants at home to make an indoor environment comfortable and elegant and, more specifically, to a smart plant growing equipment for home use which enables a user to more easily manage plants to effectively grow the plants by detecting information of the environment for plant growth and the state of the plant growth in real time, and transmitting and providing the same to a portable apparatus. According to the disclosure, the technical point is a smart plant growing equipment for home use, characterized by comprising a casing, a nutrient solution tank, a nutrient supply means, a humidifier, an environmental factor sensor, a nutrient sensor, a growth sensor, a controlling substrate, and a display panel.

### GENERAL DESCRIPTION

There is a need in the art for a novel technique of indoor plant growing. The present invention provides novel systems and methods which enable optimal growing of any plant in a fully and automatically controlled growth environment, eliminating or at least significantly reducing a need for an intervention from a user.

As known, every plant has its own growth process starting from being a seed and ending in a mature plant producing flowers or offspring. This growth route typically includes several growth stages, each requiring (being characterized by) various environmental conditions, such as illumination intensity, illumination spectrum, day time and night time, temperature, humidity, amount of water, amount and kind of different nutrients, pH and air composition in the day and night.

Determination of the growth stages is critical for optimal growth of a plant. Precise determination of the start and end of each growth stage enables controlling the growth process more effectively. For optimal growth, a plant in its vegetative stage requires different environmental conditions than in its flowering stage. Therefore, by detecting and knowing a time the plant progresses from one stage to another, the plant can be provided with the optimal environmental conditions for its growth during the various growth stages, resulting in a better harvest during a relatively short time.

Typically, determination of the growth stage is done visually and physically by checking various qualitative and quantitative parameters and conditions of the plant by the naked eye. This requires experience to be able to diagnose the growth stage and decide about the optimal environmental growth conditions. Besides, visual and physical inspections require that the plant stays available for both examinations. On the other hand, being visually and physically available means that full control over the environment is missing, such as control over light, temperature, humidity and others.

The present invention solves the above problems and provides a fully environmentally-insulated growth area/zone to the plant, such that full control of the environmental conditions is achieved and matched to each specific growth stage. It should be understood, that the term “environmentally-insulated” or “fully environmentally-insulated”, as used in the present application, means total isolation from external environmental conditions including illumination, temperature, humidity and air composition. Such environmental insulation actually screens the plant and the plant growth zone from the surroundings and does not allow visual observation/evaluation of the plant parameters.

The present invention in its one aspect provides a plant-growing system comprising a control system configured and operable for controlling plant growth in a plant growing cell inside a plant growing device under insulated environmental conditions. The control system comprises:

data input utility for receiving sensing data comprising data indicative of one or more physical parameters of the plant being grown under said insulated environmental conditions, and data indicative of one or more environmental conditions at least inside said plant growing device; and

data processor utility comprising a first analyzer utility for analyzing said data indicative one or more environmental conditions, a second analyzer utility for analyzing said data indicative of the one or more physical parameters of the plant, and determining a time pattern of each of said one or more parameters of the plant, and upon identifying a predetermined change in said one or more parameters of the plant, generating operational data comprising at least flow data for operating a dosing system being in fluid communication with the plant growing device for supplying a plurality of nutrients into the plant growing cell under a predetermined growth protocol.

The operational data comprises data indicative of one or more operational parameters for one or more environmental controllers to provide predetermined environmental conditions.

The data indicative of one or more environmental conditions may further comprise at least one environmental condition in surroundings of the plant growing device (i.e. outside thereof).

The physical parameter(s) of the plant comprise at least one of dimension, shape, and color pattern of the plant being grown in a plant-growing space above the cell while under said insulated environmental conditions. In some embodiments, the input data indicative of the one or more physical parameter of the plant comprises image data, e.g. pictures and/or video. To this end, a camera is appropriately installed inside the plant growing zone to provide pictures and preferably video of the plant being grown.

The input data indicative of one or more environmental conditions may comprise one or more of the following conditions in a plant-growing space above the cell: illumination; temperature; humidity; air composition indicative of carbon dioxide contents; odor.

Also, the input data indicative of the environmental condition(s) may comprise at least one environmental condition inside the plant growing cell, such as temperature, pH, TDS/EC, fluid level.

The plant-growing system further includes an environmentally-insulated housing comprising: a plant-growing cell configured and operable to receive a water-based solution for planting a plant therein, and defining a plant-growing space above said cell; and a dosing system connected to said plant-growing cell and being configured and operable for selectively delivering each one of a plurality of nutrients into the plant growing cell, said dosing system comprising: a platform having a plurality of receivers arranged in a spaced-apart relationship each being configured for removably receiving a nozzle of a cartridge; and a corresponding plurality of valves configured and operable for selectively providing fluid communication between the respective receiver and said plant growing cell.

In some embodiments, the cartridge comprises a sealed fluid nutrient bag having a nozzle for discharging the fluid nutrient, and a substantially rigid housing enclosing said bag such that said nozzle fixedly protrudes out of the housing, to enable the protruded nozzle to be fixed in a matching receiver.

Preferably, there is also provided a monitoring system comprising a plurality of sensors configured and operable to monitor and control various environmental conditions based on a predetermined growth protocol, and for monitoring one or more parameters of the plant being grown, and generating sensing data indicative thereof.

The monitoring system may comprise one or more of the following: a light source, a light sensor, a temperature sensor in said plant-growing space, a humidity sensor, a temperature sensor in said cell, a pH sensor, a TDS/EC sensor, a fluid level sensor, an odor sensor, a climate control system and an odor neutralizing system. The environmental conditions to be controlled may comprise one or more of the following: light intensity in said space, light spectrum in said space, temperature in said space, humidity in said space, air composition in said space, temperature of said water-based solution, pH of said water-based solution, fluid level in said cell of said water-based solution.

As indicated above, such monitoring system preferably includes an imager (one or more cameras) configured and operable to monitor the physical parameter(s) of the plant which comprise at least one of dimension, shape and color of the plant being grown in a plant-growing space above the cell while under said insulated environmental conditions.

Preferably, the configuration is such that the temperature sensor in said cell, pH sensor and TDS/EC sensor are located inside a single perforated bag configured to be immersed in the water-based solution. Also, a perforated frame may be provided for locating in said plant-growing space at a specific distance above the plant-growing cell and being configured and operable to increase surface area of the plant by passing each grown branch of the plant through one perforation in the perforated frame.

The system may further include one or more additional tools affecting the plant growth process. These may include a fan located in the plant-growing space and configured and operable to cause movement of leaves of the plant to thereby increase efficiency of the plant growth; illuminators, e.g. including back illuminator; etc. These additional tools may be controllably operated to vary their operational parameters (e.g. illumination intensity) in accordance with the plant growing protocol. The plant growing protocol may be updated/optimized based on the input data about the plant parameters.

The monitoring system may be configured and operable to maintain the water-based solution and the plant-growing space in two different temperatures. The system may be configured such that a water inlet connects to a water mains at one side and to the plant-growing cell at the other side at a point above the water-based solution level.

The hydroponic plant-growing cell may comprise a cover configured for partial displacement to thereby enable accessing roots of the plant inside the water-based solution without removing the whole cover.

The system may also include a communication utility configured and operable to communicate with an external communication device which controls the plant-growing device and tracks the plant growth.

The system may be configured for self-assembly at home. The housing may have dimensions substantially not exceeding 65, 65 and 210 cm, for its width, depth and height respectively. The internal walls of the housing defining said plant-growing space may comprise a light reflective material.

The nutrient dosing system may comprise pumps (e.g. peristaltic pumps) or any other suitable mechanical and/or electronical assemblies configured and operable to transfer nutrients from said nutrient cartridges to the hydroponic plant-growing cell. For example, the dosing system may include one or more fluid connectors for controllably flowing one or more nutrients to the plant-growing cell (i.e. not necessarily via pumping).

A plurality of pots may be used each contacting the water-based solution in the hydroponic cell to thereby grow a respective plurality of plants. According to another broad aspect of the invention, it provides a dosing system for use in a plant growing system for selectively delivering each one of a plurality of nutrients into a plant growing cell. The dosing system comprises: a platform having a plurality of receivers arranged in a spaced-apart relationship each being configured for removably receiving a nozzle of a cartridge; and a corresponding plurality of valves configured and operable for selectively providing fluid communication between the respective receiver and said plant growing cell.

The plurality of receivers may comprise at least two receivers of different geometries for receiving the nozzles of different geometries, respectively.

According to yet another broad aspect of the invention, there is provided a cartridge carrying fluid nutrient for use in the above-described dosing system. The cartridge comprises: a sealed fluid nutrient bag having a nozzle for discharging the fluid nutrient, and a substantially rigid housing enclosing said bag such that said nozzle fixedly protrudes out of the housing, to enable the protruded nozzle to be fixed in the respective matching receiver.

Preferably, the cartridge is configured such that the nozzle has a tip portion configured for being punched upon its fixation to the matching receiver.

The invention in its yet further broad aspect provides a plant-growing device, in particular for home-use. In some embodiments, the device comprises: an environmentally-insulated housing comprising: a hydroponic plant-growing cell configured and operable to receive a water-based solution for planting a plant therein; a plant-growing space above said cell; and a monitoring system configured and operable to monitor one or more physical parameters of the plant comprising at least one of the following: a dimension of the plant being grown in a plant-growing space above the cell while under said insulated environmental conditions, shape of the plant, and color pattern of the plant.

In some other embodiments, the device comprises: an environmentally-insulated housing comprising: a plant-growing cell configured and operable to receive a water-based solution for planting a plant therein; a plant-growing space above said cell; and a sensing unit located in said cell for monitoring one or more parameters of the water based solution, said sensing unit comprising at least two of temperature sensor, pH sensor and TDS/EC sensor, and a bag containing said sensors, said bag being configured to expose the sensors to the exterior of the bag for their intended operation and being displaceable between its positions within and out of the cell.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a block diagram illustrating an embodiment of a plant growing system according to the invention;

FIGS. 2A-2C are different schematic views of an embodiment of a plant growing device according to the invention;

FIG. 3 is a schematic view of an embodiment of a plant growing device according to the invention;

FIG. 4 is a schematic view of a dosing system used in a plant growing system of the invention;

FIG. 5 is schematic view of a nutrient cartridge used in a dosing system of the invention;

FIG. 6 schematically exemplifies a plant growing kit for self-assembly of a plant growing device according to the invention;

FIG. 7 schematically shows features which are monitored or managed by the plant growing device of the invention;

FIG. 8 schematically shows some of the main components of an embodiment of a plant growing device according to the invention;

FIG. 9 schematically shows different stages of plant growing by the plant growing device;

FIG. 10 schematically shows a screen shot of a smartphone running a dedicated application for monitoring and managing the plant growing device according to the invention; and

FIG. 11 schematically describes a method for using a plant growing device of the present invention.

### DETAILED DESCRIPTION OF EMBODIMENTS

For a better understanding of the invention and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention. From the description taken together with the drawings it will be apparent to those skilled in the art how the several forms of the invention may be embodied in practice. Moreover, it is to be understood that the phraseology and terminology employed herein is for the purpose of description and should not be regarded as limiting the scope of the invention hereof.

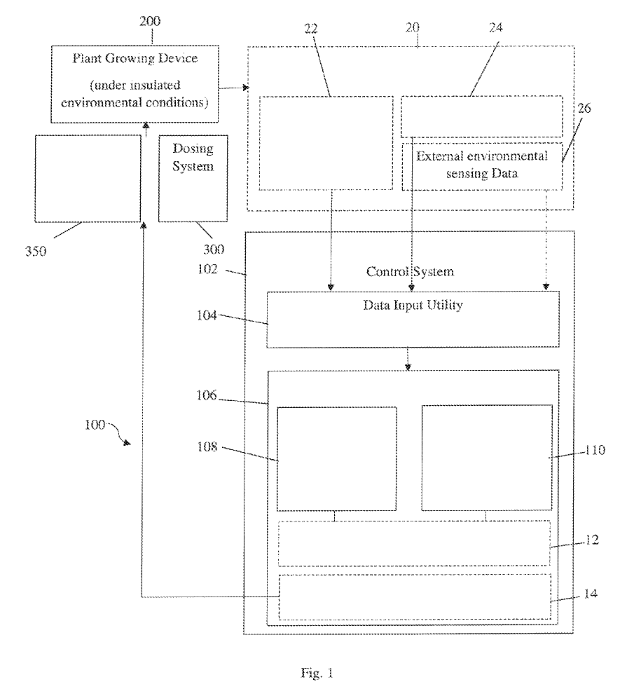

Reference is made to FIG. 1 exemplifying a plant-growing system 100 configured in accordance with an embodiment of the present invention. The system 100 includes a control system 102 configured and operable for controlling plant growth in a plant growing cell inside a plant growing device 200 when maintained under insulated environmental conditions. The environmental conditions in which the plant growing device is maintained, and consequently the plant being grown as well, will be described more specifically further below.

The control system 102 is typically a computer-based system having various hardware/software utilities including inter alia a data input utility 104, a processor utility 106, and a memory unit (not specifically shown in the figure), and typically also includes a communication utility for communicating with external devices, such as the plant growing device 200, via wired or wireless data communication protocols being well known in the art.

The data input utility 104 is configured and operable for receiving sensing data 20 which includes at least data indicative of one or more physical parameters of the plant 22, when grown under the insulated environmental conditions, and data indicative of one or more environmental conditions 24 in the insulated plant growing cell. The sensing data 20 is typically obtained by a monitoring system located inside the plant-growing device and including a plurality of sensors which monitor different environmental conditions. Optionally, additional sensing data 26 including environmental conditions in surroundings of the plant growing device may be provided to the control system 102 as well, by dedicated monitoring sensors on the plant growing device or in its vicinity. All the sensing data may be transmitted from the plant growing device 200, and possibly from its surroundings, to the input utility 104 of the control system 102 via wired or wireless communication methods.

The data processing utility 106 is connected to the data input utility 104 for receiving the sensing data 20 (at least the physical parameters of the plant 22 and the environmental conditions 24) and processing and analyzing it. To this end, the data processing utility 106 includes a first analyzer utility/module 108 configured and operable for analyzing the data indicative of the one or more physical parameters of the plant 22, and a second analyzer utility/module 110 for analyzing the data indicative of one or more environmental conditions 24 and possibly the external environmental conditions 26, and determining a time pattern 12 of each of the one or more physical parameters of the plant 22, e.g. tracking the change in the values of the physical parameters 22. Upon identifying a predetermined change in the one or more physical parameters of the plant 22, the processing utility 106 generates operational data 14 which includes at least flow data for operating a dosing system 300 being in fluid communication with the plant growing device 200 for supplying a plurality of nutrients into the plant growing device 200 to feed the growing plant and consequently keep track of its growth stage (seedling, vegetative, flowering, maturity, etc.) according to a predetermined growth protocol.

The operational data 14 generated by the data processing utility 106 may also include operational parameters to control the operation of one or more environmental controllers 350, such as a climate system or a light source, as will be further detailed below, for providing predetermined environmental conditions which are optimal for the current growth stage of the plant.

As described above, according to the invention, the growth stages of a plant are tracked by acquiring data about the physical condition of the plant, its size, including its height, from seed to vegetative to mature plant. To this end, the control system 102, by receiving and analyzing the sensing data 20, i.e. the values of the physical parameters of the plant, detects/identifies the current growth stage of the plant. Consequently, the control system operates to either maintain the existing (current) feeding regime, i.e. it may instruct the dosing system to keep on the same flow of nutrients into the plant growing device 200, or generate a different recipe of the feeding of the plurality of nutrients into the plant growing device 200, in order to stimulate, support or accelerate the transmission of the plant from one growth stage to a subsequent one.

Additionally, the control system 102 continuously monitors, in real time, the environmental conditions 24 inside the plant growing device 200, and generates whenever the need arises, data indicative of the desired values of the environmental conditions, either to enhance the growing speed, induce the transmission to a following growth stage, or simple support the growth stage.

The physical parameters of the plant 22, which are monitored while under the insulated environmental conditions of the plant, and included in the sensing data, include at least one of the following: plant dimension (i.e. the plant's height, and/or width, and/or size of the branches or leaves); shape of the plant; and color pattern of the plant. The color of the plant may indicate deficiency in one or more minerals or vitamins, and thus triggers the control system 102 to generate a suitable flow data to the dosing system 300 to release or stop releasing of specific nutrients.

The data about the physical parameters of the plant 22 may include or derived from image data acquired by a suitable imaging sensor found inside the plant growing device 200, such as camera(s), or an acoustic or optical sensor. The images from a camera, being photos or video clips, are processed by the control system to determine, inter alia, shape or color pattern of the plant. The acoustic or optical sensors can measure distance from objects, such as to measure the height of the plant, being the point with the shortest measured distance, given that the sensor is positioned at the top of the growth area of the plant.

The data relating to the environmental conditions 24 inside the plant growing device 200, typically include two kinds of sensing information, the first is from the space in which the plant is growing with its branches and leaves, and the second is the region in which the roots of the plant are. In the first kind, the following environmental conditions are monitored: illumination (intensity or and/or spectrum), temperature, humidity, air composition indicative of carbon dioxide contents and odor. In the second kind, the following environmental conditions are monitored: temperature, pH, Total Dissolved Solids in a solution (TDS), Electrical Conductivity (EC) which indicates some of the contents in a solution, and fluid level. The environmental conditions TDS and EC are typically monitored if the growing method is Hydroponics, i.e. growing plants in a water-based solution, which is convenient to perform and to control in an insulated environment. Hydroponics is one of the preferred methods to implement the invention, though the invention is not limited to this method, and can be applied and practiced with other methods such as with regular soil medium for planting the plant. In the latter case, there are other methods to monitor the fertilizing ingredients in the soil, which while not being specifically described here, this is known to a skilled man in the art. The present invention, in its illustrating non-limiting embodiments utilizes the hydroponic method as a non-limiting example only and for the sake of simplicity.

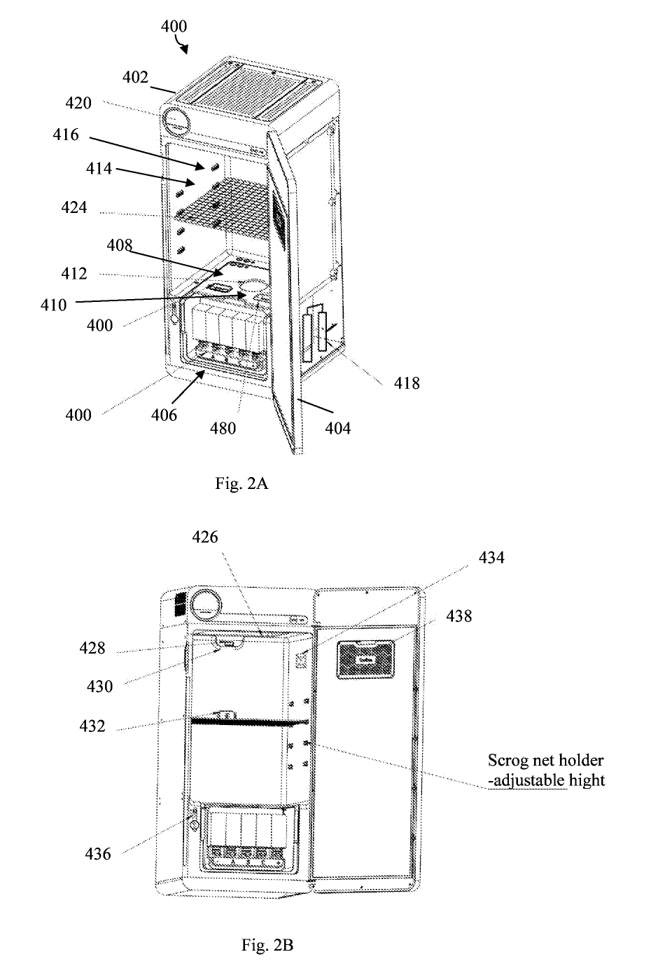

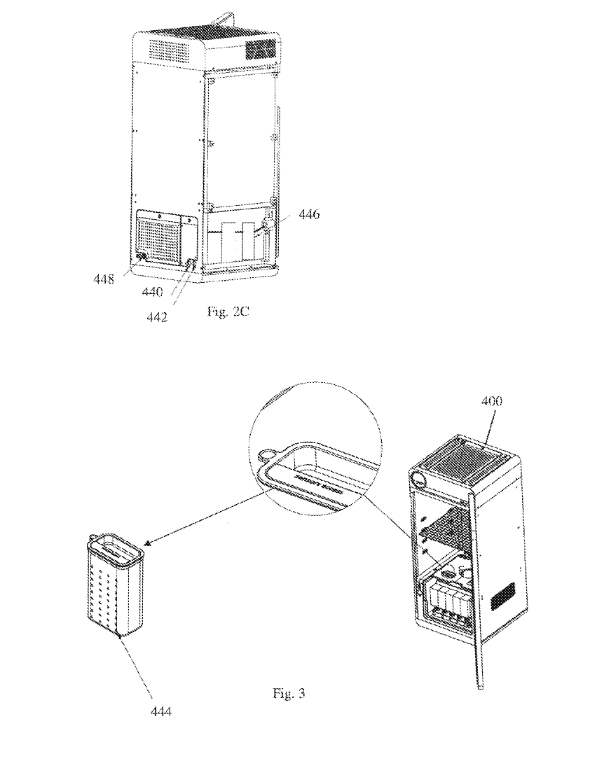

Reference is made to FIGS. 2A-2C illustrating different side views of a non-limiting example of a plant growing device 400 according to one embodiment of the invention. As shown, the plant growing device 400 includes a housing 402 having a door 404. The housing 402 may typically have dimensions not exceeding 65, 65 and 210 cm, for its width, depth and height respectively, to enable its easy transportation into and outside of a building. As mentioned, one of the main uses of the device 400 is growing plants at home where the door entrances limit the mobility of big appliances. Inside the housing 402, there are three main compartments, from down up, a lower compartment 406 for accommodating different facilities such as a dosing system and a climate system, as will be described below, a compartment 408 in the middle for accommodating a plant growing cell 410, e.g. a hydroponic growing cell is shown with a plant pot 412 placed on it in which the plant seeds are placed, and an upper compartment 414 functioning as a plant-growing space 416 and includes different sensors that monitor the environmental conditions 24 and the physical parameters of the plant 22, as will be further detailed below. It should be understood that during growing plants, the device 400 is kept with its door 404 closed at all times, except for special occasions such as the need to take care of some of the operational systems inside. As such, the device 400 provides a totally insulated environment including from external light, temperature and air, so to make the growing space 416 and cell 410 totally controlled by the different controllers such as the climate system and the light source which are described below.

The plant-growing cell 410 is configured and operable to plant seeds of a plant therein (in the pot 412). For example, if the growing method is Hydroponics, then the cell 410 is adapted to receive a water-based solution for planting a plant in the solution. FIG. 2A shows the exemplified internal components of the device 400 from the front and left sides. As further illustrated, the device 400 includes a climate control system 418, for controlling the temperature of the air in the plant growing space 416, and possible may also be costumed to control the air composition inside the space 416. The device 400 also includes an odor neutralizer 420 such as a carbon filter functioning to purify the air inside the space 416 and remove strong scents that accompany the growing process. A dosing system 422 is also shown in the lower compartment in front of the plant-growing cell 410 and will be described below in detail. Inside the space 416, there is a scrog net 424 placed horizontally, which height can be adjusted (can also be seen in FIG. 2B). The scrog net 424 is actually a perforated frame being configured and operable to increase surface area of the plant after it starts to give branches by passing each grown branch of the plant through one perforation in the perforated frame. This way, the exposure of all parts of the plant to the growing environment, such as the light, is enhanced and results in accelerated and more effective growing. Root access window 480 is also provided in the plant cell 410. The window allows for visual as well as physical access to the plant roots inside the water-based solution.

In FIG. 2B, an illumination source 426 is shown, this could be a LED source or any other light source that can be used to illuminate the plant according to a predetermined lighting protocol to match the different growing stages of the plant and to provide optimal illumination, whether intensity or spectrum, at all times. A light sensor integrated with the light source senses the illumination profile inside the housing and sends the sensing data to the control system 102 so that it can generate modification of the light source's output. Different LED illumination modules can be integrated to ensure productivity while consuming low energy resources. There are many illumination modules used to grow plants indoors, some are specifically suitable for growing specific plants, such as Cannabis, in a cost efficient manner indoors. Also shown is a camera 428 which role has been partially described above. It enables viewing the plant, by pictures or live videos, at all growth stages, without the need to open the door 404, so that the environment inside the plant growing device is kept controlled at all times. In addition, the camera 428 acquires data which may be processed to obtain data about the color pattern and size of the plant as described above. In addition, image processing can also be utilized to detect abnormalities such as disease or parasites, alert the user and adjust growing conditions to minimize damage Alternatively, the stage of growth can be deduced by a timer timing the time passed since the date the seeds were planted. The timer is also used to determine the time of day and to schedule the automatic activation of various modules of the plant growing device. In addition to or instead of image processing of images from the camera 428, a height sensor 430 is provided in the device 400 as shown to acquire information about the height of the plant. The height sensor may be an acoustic or optical sensor. The determination of the plant's height is one of the indications in which a plant may be moving from a vegetative to flowering stage, and thus the information is important and helps the control system 102 to modify the flow data to the dosing system 422. An air temperature and humidity sensor(s) 432 is also included to sense these environmental conditions. A fan 434 is included to take out the air and cause circulation of the air inside thus keeping the plant in as close as possible, and even more optimal, to outside nature (moving wind). A fresh water supply is guaranteed by the provided water input/output 436 standalone mode. The connection 436 may also provide discharge of water which has been used for a while and needs to be changed. General tool box 438 which are needed during the routine work with the device, the planting and growing processes may be provided as well, e.g. hung on the inside of the door 404.

As shown in FIG. 2C, in addition to or instead of the water input/output 436 standalone mode, the device may be provided with water input and outputs connections 440 and 442 to water mains infrastructure. The city-water inlet 440 is positioned above the water-based solution level inside the cell to prevent contamination of the water in the infrastructure. Also shown in the figure are the water pumps 446 which control the delivery of water to and from the plant-growing cell 410, and a power inlet 448 configured to connect the device to electricity.

Reference is made to FIG. 3, in which the device 400 is shown and a sensor box 444 is illustrated. The sensor box 444 keeps all the sensors, configured to monitor the environmental conditions inside the planting cell 410, together. Theses sensors, temperature sensor, water level sensor, pH and TDS/EC need to be calibrated before, and possibly during, each plant growing procedure. Therefore, keeping them together in the single box 444 facilitates the treatment that should be done to each of them. The sensors can be accessed while still in the close vicinity of the device 400 for great convenience and manageability.

It should be noted that the device 400 is capable of controlling the water and air temperatures differently and maintaining two different temperatures, or ranges of temperatures, as needed in the water and air separately.

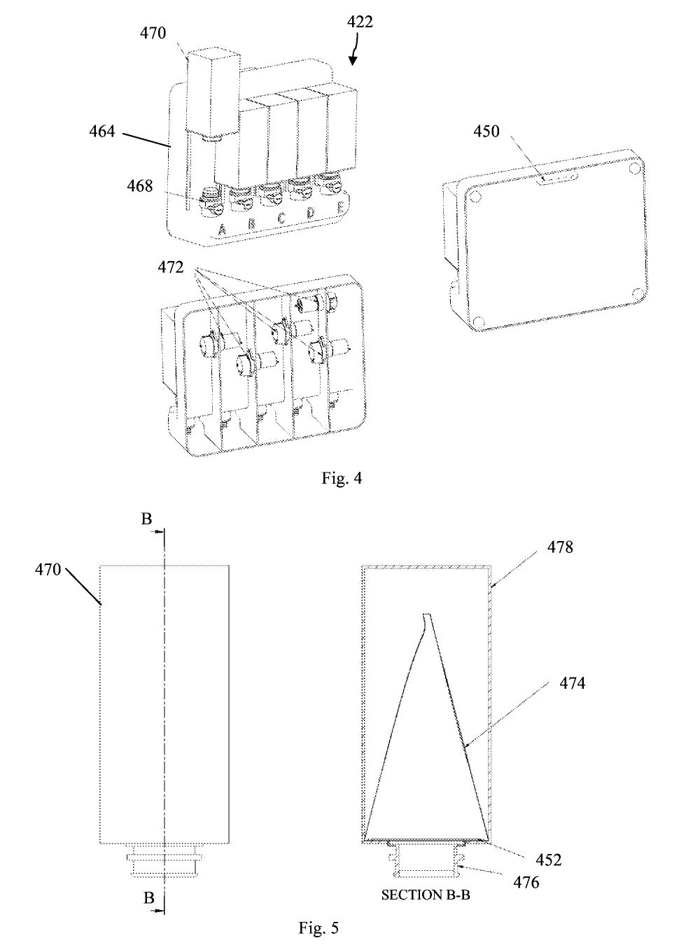

As described above, the present invention also provides a novel dosing system (300, 422) which is responsible for selectively dispensing/delivering the required amounts of each of a plurality of nutrients into the water-based solution inside the plant growing cell 410. Reference is made to FIG. 4 showing the dosing system 422. As shown, the dosing system includes a platform 464 having a plurality of receivers 468, five such receivers are shown as a non-limiting example, arranged in a spaced-apart relationship and each being configured for removably receiving a nozzle of a cartridge 470. It should be understood that each receiver may be constructed differently to match an equal number of different nozzles of the cartridges. Each receiver is then connected to a valve 472, on the backside, configured and operable for selectively providing fluid communication between the respective receiver and the plant growing cell 410. For example, the valve 472 may be connected to or structured as a peristaltic pump or a solenoid assembly. On the right, the backside with a cover on protecting the valves is shown and aimed at illustrating five distinct outputs 450 connecting the valves/receivers to hoses (not shown) for delivering each cartridge content to the plant-growing cell. It should be noted, that each cartridge 470 carries a specific nutrient or mixture of nutrients, and one or more may also carry a pH stabilizer, such that the dosing system is capable of delivering one or more nutrients simultaneously or sequentially in exact timing and dosage as will be automatically instructed by the control system 102.

FIG. 5 schematically shows a replaceable (disposable) nutrient cartridge 470. The figure on the left shows the front side of such a cartridge while the figure on the right is a longitudinal cross sectional view along the axis B-B. The replaceable nutrient cartridge 470, can be supplied as a set of cartridges which should be periodically replaced, an alert for replacing each replaceable nutrient cartridge can be provided to the user through a dedicated display on the device 400 or on a hand-held device, such as a smartphone running a suitable application, as will be described further below. The cartridge includes a sealed fluid nutrient bag 474, made possibly from aluminum or plastic and having a nozzle 476 for discharging the fluid nutrient. The nozzle may have a tip portion (not shown) sealing the nutrient bag and configured to be punched upon its fixation to the matching receiver. A housing 478 encloses the bag 474 such that the nozzle 476 fixedly protrudes out of the housing 478, to enable the protruded nozzle to be fixed in a matching receiver 468. The bag and the housing may be adhered to each other at 452. The housing 478 is made from a rigid material to enable easy gripping by hand of the cartridge. The cartridges may be constructed to be reusable by re-filling or may be totally disposable and consumable.

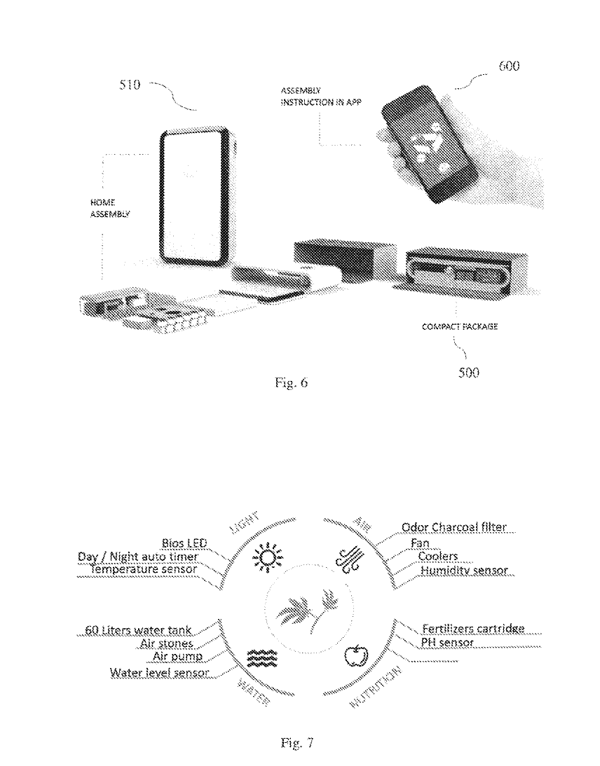

FIG. 6 schematically shows a plant growing kit for self-assembly of a plant growing device according to another non-limiting embodiment of the invention. The plant growing kit 500 may be purchased on-line and shipped to the customer. The customer can download an application to his smartphone 600 via a website, or by scanning a QR code on the plant growing kit package 500. The smartphone application 600 includes instructions of how to assemble the plant growing device 510. Alternatively, the plant growing kit 500 can be purchased at a store and assembled by a printed user manual.

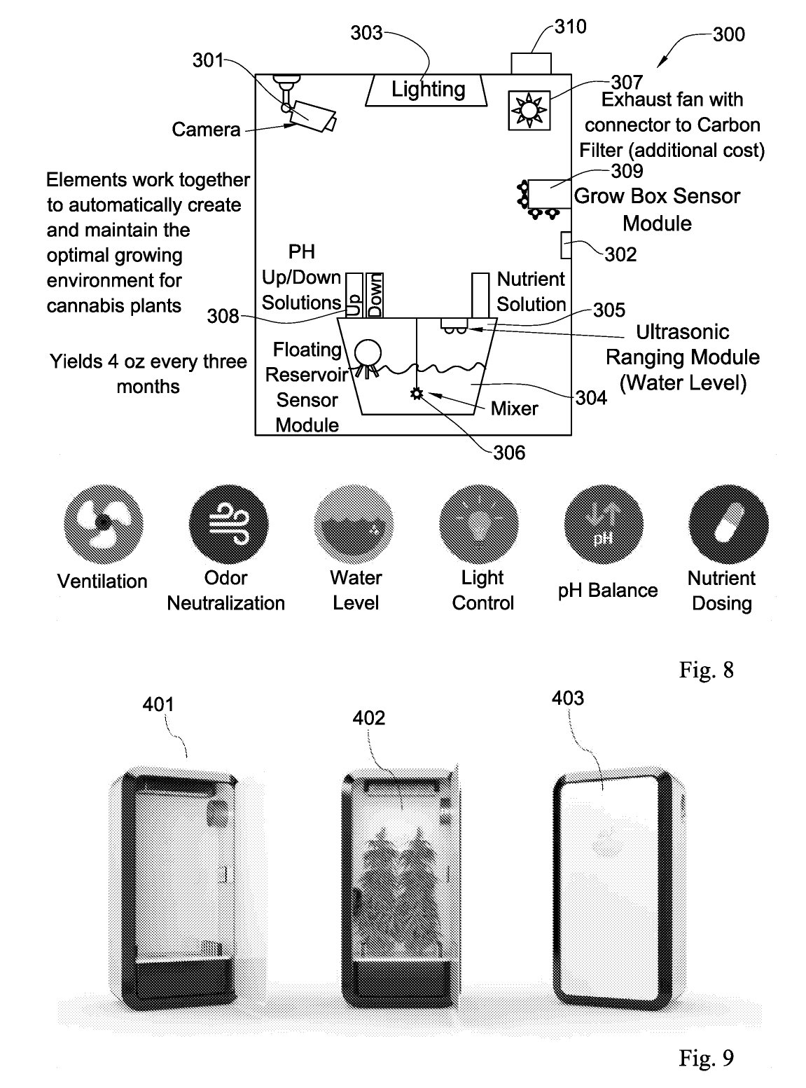

FIGS. 7 and 8 schematically further show features, some of which have been described above, which are monitored or managed by the monitoring system of the plant growing device 510. As described above, the plant growing device 510 enables monitoring and control over the environment inside the plant growing device 510 by sensors and detectors which trigger activation of fans, LED illumination, filters, nutrients and irrigation in accordance with the requirement according to a predetermined protocol adapted to the stage of growth in which the plant is at. The stage of growth in which the plant is at can be determined by image processing of an imaging sensor 301 inside the plant growing device. The imaging sensor 301 can be based on a small video camera. Parameters such as the size of the plant, its shape and color can be extracted to assess the stage of which the plant is at and to adjust the device to provide optimal growing conditions in accordance.

A light detector 302 monitors the amount of light produced by the LED illumination module 303. Also, in some embodiments, the monitoring system may additionally include an external sensing system 310 for sensing various parameters/conditions in the surroundings of the plant growing device, such as temperature and humidity. This facilitates optimization of the environmental conditions inside the plant growing device, while keeping the inside region thereof fully environmentally insulated.

Preferably the growing device utilizes a hydroponic growing method. A 60 liter water tank 304 is used to water the plant. A water level sensor 305 provides indication when water should be added to the water tank 304. A water mixer 306 is used to mix the water with the nutrient solution to provide consistent distribution of nutrients in the water tank 304 and air stones are used to increase the amount of oxygen entering the water, this helps maintain hygiene and provides oxygen to the plant roots. An exhaust fan is used to recycle the air in the system by pushing out existing air in the system, the air is filtered through the odor neutralizing filter 307 before it is removed from outside the device. A fan is used to circulate the air evenly inside the device. A humidity sensor is used to detect the amount of humidity and a temperature sensor is used to detect the temperature inside the device and to activate the fan and the cooling system accordingly to reach optimal conditions at all times. The odor neutralizing filter 307 can be based on a replaceable charcoal filter. A PH sensor 308 is used to indicate the PH level inside the water in the reservoir 304. A TDS/PPM sensor 308 is used to detect the level of nutrients in the water in the reservoir 304. A microprocessor 309 receives the inputs from all the sensors and detectors and a micro transceiver transmits the information to the smartphone application and receives commands from the smartphone application. The communication can be based on WiFi, Bluetooth or any other communication protocol.

The device has 3 different sensors situated within the water (pH, Total Dissolved Solids (TDS), and Water Temperature). The sensors in the water determine the quality of the most important thing to a plant grown hydroponically—the water. The device can analyze according to the information provided from these sensors how much nutrients are in the water, what the pH level is, and based on that the device can change its other settings for example the fan speed, the amount of nutrients to dispense to the water etc. The device includes an automatic dosing module in the form of replaceable capsules that automatically dose nutrients and pH balancing solution based on the feedback received from the different sensors in the water and in the device (i.e., not within the water tank, sensors in the device may include air temperature, air humidity, light intensity). The plant growing device takes all these different parameters into account every time it does anything, including nutrient and pH dosing.

FIG. 9 schematically shows different stages of plant growing by the plant growing device. At first seeds are planted inside the planting hydroponic planting area 401. The device automatically activates the lighting, cooling, watering and nutrients as optimal to cultivate a seed in accordance with the predetermined protocol of the microprocessor. As the seed grows, the microprocessor adjusts the operation of the device for optimal cultivation of a grown plant. The stage of growth in which the plant is at can be determined by image processing of an imaging sensor inside the plant growing device. The imaging sensor can be based on a small video camera. Alternatively, the stage of growth can be deduced by a timer timing the time passed since the date the seeds were planted. The timer is also used to determine the time of day and to schedule the automatic activation of various module of the plant growing device. 403 is a closed device, the device has a door for accessing the plant. It is preferable to refrain from unscheduled opening of the door in order not to disturb the cultivating conditions of the plant. The device and door are sealed and block external light to avoid undesired deviations from optimal cultivating environment which is constantly provided within the device. The door has a lock which the user can lock or unlock the door utilizing for example the smartphone application. The user can check on the cultivation process and view the plant in real time via video which can be transmitted from the video camera inside the device and transmitted to the smartphone application of the user. The sealing of the device is also preferable to avoid undesired odor from existing the device. The exhaust air from the device is being filtered through a charcoal filtering odor neutralization filter to minimize undesired odor from dissipating out of the device.

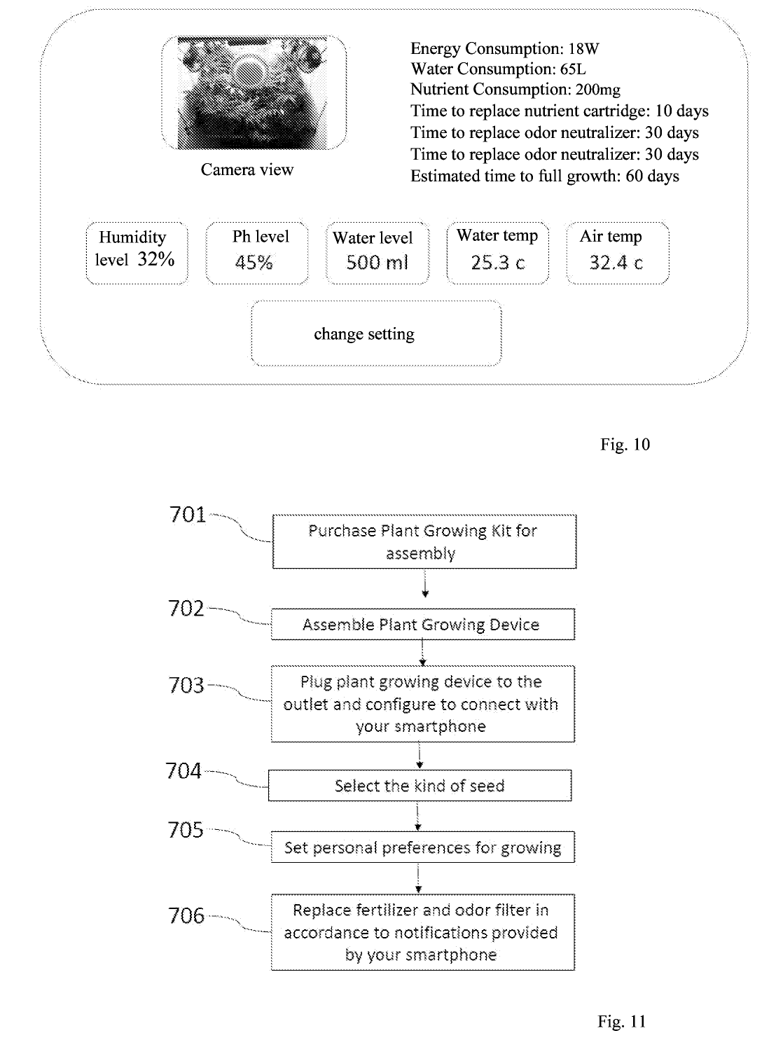

FIG. 10 schematically shows a screen shot of a smartphone application for monitoring and managing the plant growing device. The smartphone application provides real time video view of the plant inside the growing device. Readings from the sensors are provided, such as the level of humidity, pH, temperature in the growing space, temperature in the water inside the cell. Information is extracted from the sensors and selected cultivation protocol may also be provided such as the resources consumption (electricity\water\nutrients\odor neutralization filter etc.). The user can reconfigure the settings according to his preference.

FIG. 11 schematically describes a method for using a plant growing device. The plant growing device can be collapsed into a small package and designed to be built by layman via a user manual or a video tutorial which can be accessed through the internet. In step 701, the package can therefore be purchased on-line and shipped to the customer, alternately the customer can purchase the package on his own in any retail store or request service for transporting and assembling the package. The seeds are purchased separately. After the customer assembles the package 702, the plant growing device is connected to an electricity outlet the customer synchronizes his smartphone to communicate with the plant growing device 703 via a device management application which is installed on his smartphone from the internet. The user presets the settings of the kind of seed and strain 704, and his preferences for the growing process 705—optimal for the plant vs. cost effective, the customer can view the amount of resources required to grow the plant according to the program of his choice, the resources are the amount of electricity expected to be usurer and the nutrients and filter modules which should be required during such growing process. The ongoing maintenance of the device-odor filter replacement, water, and nutrients 706 is determined according to the program selected by the user. Image analysis can also be utilized to assess in real time the conditions of the plant and to adjust the cultivating conditions to suit its needs. The user can also select the periodic notifications that he would like to receive about the status of the growing process which will be pushed to his smartphone application.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference.

In addition, citation or identification of any reference in this application shall not be construed as an admission that such reference is available as prior art to the present invention.

1. A plant-growing system comprising a control system configured for controlling plant growth in a plant growing cell inside a plant growing device under insulated environmental conditions, the control system comprising:
data input utility for receiving sensing data comprising data indicative of one or more physical parameters of the plant being grown under said insulated environmental conditions, and data indicative of one or more environmental conditions at least inside said plant growing device; and
data processor utility comprising a first analyzer utility for analyzing said data indicative one or more environmental conditions, a second analyzer utility for analyzing said data indicative of the one or more physical parameters of the plant, and determining a time pattern of each of said one or more parameters of the plant, and upon identifying a predetermined change in said one or more parameters of the plant, generating operational data comprising at least flow data for operating a dosing system being in fluid communication with the plant growing device for supplying a plurality of nutrients into the plant growing cell under a predetermined growth protocol.

2. The system of claim 1, wherein said data indicative of one or more environmental conditions further comprises at least one environmental condition in surroundings of said plant growing device.

3. The system of claim 1, wherein said operational data comprises data indicative of one or more operational parameters for one or more environmental controllers for providing predetermined environmental conditions.

4. The system of claim 1, wherein said one or more physical parameters of the plant being grown in a plant-growing space above the cell while under said insulated environmental conditions, comprise at least one of the following: dimension, shape, and color pattern of the plant.

5. The system of claim 4, wherein said input data indicative of the one or more physical parameter of the plant comprises image data of the plant.

6. (canceled)

7. The system of claim 1, wherein said input data indicative of the one or more environmental conditions comprises at least one of the following conditions in a plant-growing space above the cell: illumination; temperature; humidity; air composition indicative of carbon dioxide contents; odor; and at least one of the following conditions inside said cell: temperature, pH, TDS/EC, fluid level.

8. (canceled)

9. The system of claim 1, further comprising:
an environmentally-insulated housing comprising: a plant-growing cell configured and operable to receive a water-based solution for planting a plant therein, and a plant-growing space above said cell;
a dosing system connected to said plant-growing cell and being configured and operable for selectively delivering each one of a plurality of nutrients into the plant growing cell, said dosing system comprising: a platform having a plurality of receivers arranged in a spaced-apart relationship each being configured for removably receiving a nozzle of a cartridge; and a corresponding plurality of valves configured and operable for selectively providing fluid communication between the respective receiver and said plant growing cell; and
a monitoring system comprising a plurality of sensors configured and operable to monitor and control various environmental conditions based on a predetermined growth protocol, and for monitoring one or more parameters of the plant being grown, and generating sensing data indicative thereof.

10-11. (canceled)

12. The system according to claim 9, wherein said monitoring system comprises one or more of the following: a light source, a light sensor, a temperature sensor in said plant-growing space, a humidity sensor, a carbon dioxide sensor, a temperature sensor in said cell, a pH sensor, a TDS/EC sensor, a fluid level sensor, an odor sensor, a climate control system, an odor neutralizing system, and at least one imager; said environmental conditions comprise one or more of the following being monitored by the respective sensor and controlled by the monitoring system: light intensity in said space, light spectrum in said space, temperature in said space, humidity in said space, air composition in said space, temperature of said water-based solution, pH of said water-based solution, fluid level in said cell of said water-based solution.

13-14. (canceled)

15. The system according to claim 12, wherein said temperature sensor in said cell, pH sensor and TDS/EC sensor are located inside a single perforated bag configured to be immersed in said water-based solution.

16. The system according to claim 9, comprising one or more of the following: a perforated frame located in said plant-growing space at a specific distance above the plant-growing cell and being configured and operable to increase surface area of the plant by passing each grown branch of the plant through one perforation in the perforated frame, and a fan located in said plant-growing space being configured and operable to cause movement of leaves of the plant to thereby increase efficiency of the plant growth.

17-18. (canceled)

19. The system according to claim 9, comprising a water inlet being configured and operable to connect to a water mains at one side and to the plant-growing cell at the other side at a point above the water-based solution level.

20. The system according to claim 9, wherein said plant-growing cell comprises a cover being configured for partial displacement to thereby enable accessing roots of the plant inside the water-based solution without removing the whole cover.

21. The system according to claim 9, comprising a communication utility configured and operable to communicate with an external communication device configured and operable to control the plant-growing device and track the plant growth.

22. The system according to claim 9, being configured for self-assembly at home.

23. (canceled)

24. The system according to claim 9, wherein internal walls of the housing defming said plant-growing space comprise a light reflective material.

25. The system according to claim 9, wherein said nutrient dosing system comprises one or more of the following: dosing pumps configured and operable to transfer nutrients from said nutrient cartridges to said plant-growing cell; and one or more fluid connectors for controllably flowing one or more nutrients to the plant-growing cell.

26. (canceled)

27. The system according to claim 9, comprising a plurality of pots each contacting said water-based solution in said cell to thereby grow a respective plurality of plants.

28-29. (canceled)

30. A cartridge for carrying fluid nutrient, the cartridge being configured for use in the system of claim 9, the cartridge comprising a sealed fluid nutrient bag having a fixedly protruding nozzle for discharging the fluid nutrient, the protruding nozzle having a geometry enabling it to be fixed in a respective one of the receivers having a matching geometry.

31. The cartridge of claim 30, wherein said nozzle has a tip portion configured for being punched upon its fixation to the matching receiver.

32. (canceled)

33. A plant-growing device for home-use, the device comprising:
an environmentally-insulated housing comprising: a hydroponic plant-growing cell configured and operable to receive a water-based solution for planting a plant therein; a plant-growing space above said cell; and
a sensing unit located in said cell for monitoring one or more parameters of the water based solution, said sensing unit comprising at least two of temperature sensor, pH sensor and TDS/EC sensor, and a bag containing said sensors, said bag being configured to expose the sensors to the exterior of the bag for their intended operation and being displaceable between its positions within and out of the cell.
